(19) United States
(12) Patent Application Publication
(10) Pub. No.: US 2026/0149289 A1
(43) Pub. Date: May 28, 2026

(54) HYBRID POWER SYSTEM FOR GENERATOR SET

(71) Applicant: CHONGQING DINKING POWER MACHINERY CO., LTD., CHONGQING (CN)

(72) Inventors: JINBO LU, Chongqing (CN); XIANG LIU, Chongqing (CN); YUANSONG WU, Chongqing (CN); SHIQIAN XIE, Chongqing (CN); HAI XU, Chongqing (CN)

(21) Appl. No.: 18/990,510

(22) Filed: Dec. 20, 2024

(30) Foreign Application Priority Data
Nov. 26, 2024 (CN) 202411704352.5

(51) Int. Cl. H02J 7/32; H02J 7/00

(52) U.S. Cl. CPC H02J 7/32; H02J 7/61; H02J 7/63; H02J 7/82; H02J 7/96

(57) ABSTRACT

The invention provides a hybrid power system for a generator set. Current detection is arranged at a battery terminal of a step-down charge channel and a step-up discharge channel of a bidirectional module, and voltage detection is arranged at two terminals of a diode to detect whether the diode has a voltage drop to determine whether a battery is in a charge state or non-discharge state; and whether the battery is in a charge state is determined by the current detection. A generator set in a non-operating state can be aroused to charge the battery, and the charge/discharge state of the battery can be effectively monitored and controlled.

### BACKGROUND OF THE INVENTION

### 1. Technical Field

The invention relates to the field of generator power, in particular to a hybrid power system for a generator set.

### 2. Description of Related Art

In the prior art, a generator set charges a battery only when the generator set operates, and the charge/discharge state of the battery cannot be effectively monitored and controlled, which may lead to the following drawbacks: the battery cannot be charged when the generator does not operates, thus limiting the charging flexibility; the state of the battery cannot be monitored, thus possibly reducing the reliability of the generator set and leading to a failure to start the generator set; in addition, when a traditional generator operates, the battery will be charged all the time, leading to overcharge of the battery; and charging cannot be optimized according to the actual state of the battery, so aging of the battery will be accelerated due to overcharge or overdischarge of the battery.

### BRIEF SUMMARY OF THE INVENTION

The objective of the invention is to innovatively provide a hybrid power system for a generator set to at least solve the technical problems in the prior art.

To fulfill the above objective, the invention provides a hybrid power system for a generator, comprising an engine, an inverter, a battery and a bidirectional module, wherein the bidirectional module is connected to the inverter, the battery and the engine; the engine comprises a magneto;
voltage detection is arranged at a low-voltage battery terminal of the bidirectional module to detect a voltage of the battery terminal; when the voltage of the low-voltage battery terminal of the bidirectional module is higher than a set voltage threshold, it is determined that the battery is at a high state of charge;
the bidirectional module comprises a step-down charge channel and a step-up discharge channel, and monitoring elements are arranged at two terminals of the step-down charge channel and two terminals of the step-up discharge channel; specifically:
a diode is arranged at a high-voltage terminal of the step-up discharge channel of the bidirectional module, the high-voltage terminal of the step-up discharge channel of the bidirectional module is connected to an anode of the diode, and a voltage to ground of the anode of the diode is U1; a cathode of the diode is connected to the inverter, and a voltage to ground of the cathode of the diode is U0; voltage detection is arranged at two terminals of the diode to detect a voltage difference signal u of the diode, u=U1−U0; when u is greater than 0, it indicates that the engine does not operate, and a generator set is in a non-operating state; and when u is less than or equal to 0, it indicates that the engine operates, and the generator set is in an operating state;
current detection is arranged at a low-voltage terminal of the step-up discharge channel of the bidirectional module to confirm whether the step-up discharge channel is in an open state, and current detection is arranged at a low-voltage terminal of the step-down charge voltage channel of the bidirectional module to confirm whether the step-down charge voltage channel is in an open state;
the bidirectional module controls the step-down charge voltage channel and the step-up discharge channel to be opened or closed according to the voltage of the battery terminal;
(1) when the battery is at a high state of charge, the step-up discharge channel is opened, the step-down charge channel is closed, and the battery is in a discharge state, such that self-power consumption is avoided;
(2) when a voltage of the battery is lower than a charge threshold, the bidirectional module closes the step-up discharge channel and opens the step-down charge channel, and the battery is in a charge state;
(3) when the battery is at a high state of charge and the generator set operates, the step-up discharge channel and the step-down charge channel are opened at the same time, the battery is charged while discharging, and the battery is in both the charge state and the discharge state;
(4) when the generator set does not operate and whether the inverter does not output a current, the step-up discharge channel and the step-down charge channel are closed at the same time; whether the inverter outputs a current is determined by the current detection arranged at the low-voltage terminal of the step-down charge channel.

In this way, the bidirectional module can open or close the step-up discharge channel and the step-down charge channel according to the actual condition, such that the hybrid power system for a generator set realizes hybrid output of the battery and the generator set, that is, the generator set and the battery can separately output power or synchronously output power, and the generator set can be automatically controlled to start or stop according to the state of charge of the battery to realize range-extended automatic output.

Preferably, the step-up discharge channel and the step-down charge channel of the bidirectional module are opened by default.

Further, the hybrid power system for a generator set further comprises a start-stop control module, wherein the start-stop control module is connected to the bidirectional module and the engine and used for starting and stopping the engine;
in a case where the battery is at a high state of charge, the step-up discharge channel is opened and the step-down charge channel is closed, the bidirectional module sends a signal to the start-stop control module to control the engine to stop so as to stop the generator set;
in a case where the voltage of the battery is lower than the charge threshold and the bidirectional module closes the step-up discharge channel and opens the step-down charge channel, the bidirectional module sends a signal to the start-stop control module to control the engine to start so as to start the generator set.

By adopting the start-stop control module, the bidirectional module can send a signal to the external start-stop control module according to the voltage of the battery to control the engine to start or stop.

Further, the engine is started by the start-stop control module or by reverse starting.

Further, when the battery is in the discharge state, a current output by the battery is boosted by the step-up discharge channel of the bidirectional module and then inverted and rectified by the inverter, and a current output by the inverter is used for power supply to a load.

By adopting the above technical solution, the bidirectional module and the hybrid power system for a generator set designed in the invention have the advantages of intelligent charge-discharge control, generator set arousing and auxiliary power supply, synchronous charging and discharging and convenient and flexible operation, the overall performance of the system is remarkably improved, and a more efficient, stable and reliable power supply solution is provided for users. Specific advantages are as follows:
(1) Charging flexibility is improved: in a case where the generator set does not operate, the battery can be charged by intelligent control, thus breaking through the limitation that the battery can be charged only when the generator set operates in the prior art and remarkably improving the charging flexibility.
(2) System reliability is improved: by monitoring the state of the battery in real time and intelligently controlling the charge and discharge channels, normal start of the generator set is guaranteed, and the problem that the reliability is reduced because the state of the battery cannot be acquired is solved.
(3) Battery management is optimized: intelligent charge and discharge control can be performed according to the actual state of the battery to effectively avoid overcharge and overdischarge of the battery, thus greatly prolonging the life of the battery and decreasing the aging rate of the battery.

### BRIEF DESCRIPTION OF THE SEVERAL VIEWS OF THE DRAWINGS

FIG. 1 is a circuit diagram of a hybrid power system for a generator set according to the invention.

### DETAILED DESCRIPTION OF THE INVENTION

Some embodiments of the invention are described in detail below, and examples of the embodiments are shown in the drawings, in which identical or similar reference signs indicate identical or similar elements or elements with identical or similar functions. The embodiments described below with reference to the accompanying drawing are merely used to explain the invention and should not be construed as limitations of the invention.

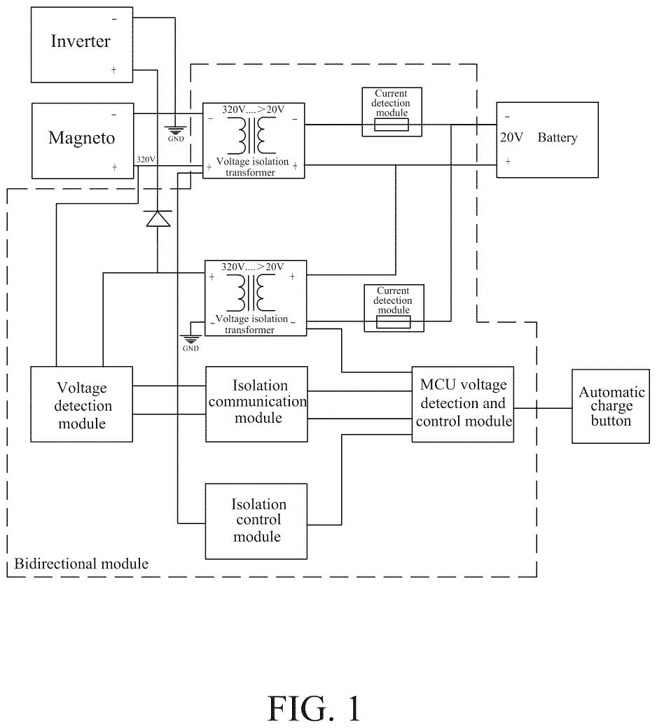

FIG. 1 is a circuit diagram of a hybrid power system for a generator set according to the invention. The invention designs a bidirectional module, which has two functions: (1) a battery and an inverter are connected by means of the bidirectional module, and when a generator is in a non-operating state, the battery directly supplies power to a load by means of the inverter, and in this case, the battery discharges independently; (2) the battery and the generator are connected by means of the bidirectional module, and the generator can be automatically started and stopped according to the state of charge of the battery, such that automatic charge and discharge control of the battery is realized. When the generator is in an operating state, the battery and generator discharge synchronously; and in a case where the battery is at a low state of charge, the battery will be charged. It can be seen from FIG. 1 that the bidirectional module comprises a step-up module (a step-up discharge channel), a step-down module (a step-down charge channel), current detection modules, a voltage detection module, an isolation control module, an isolation communication module, an MCU voltage detection and control module (voltage detection arranged at a low-voltage battery terminal of the bidirectional module) and an automatic charge button.

Each of the step-up module and the step-down module comprises a voltage isolation transformer and is connected in series with one current detection module; and the current detection modules are connected to the battery and can measure the voltage of the battery.

The isolation control module is connected to the MCU voltage detection and control module and a magneto, wherein the magneto belongs to an engine. The isolation control module is used for receiving a signal from the MCU voltage detection and control module and then controlling operation of the engine.

The isolation communication module is connected to the MCU voltage detection and control module and the voltage detection modules, and is used for determining the charge or discharge state of the battery according to the measured voltage and sending a result to the MCU voltage detection and control module.

The automatic charge button is connected to the MCU voltage detection and control module and is used for controlling the MCU voltage detection and control module (the voltage detection arranged at the low-voltage battery terminal of the bidirectional module) to start or stop.

The voltage detection module is used for detecting voltages of two terminals of a diode, wherein an anode of the diode is connected to the voltage isolation transformer of the step-up module, and a cathode of the diode is connected to the inverter. If the voltage detection modules detect a voltage drop of the diode, it indicates that the battery is in the discharge state, and at this moment, whether the battery is in the discharge state can be further confirmed by current detection to prevent a voltage drop or backswing voltage caused by signal disturbance. If the diode does not have a voltage drop, it indicates that the battery is in a non-discharge state, the generator is in the operating state, and at this moment, whether the battery is in the charge state is further determined by the current and direction modules: whether the voltage of the battery is higher than a set threshold is determined; if the voltage of the battery is higher than the set threshold, it indicates that the battery is at a high state of charge, the MCU voltage detection and control module sends out a control signal to control the magneto (engine) to stop operating; if the voltage of the battery is lower than the set threshold, it indicates that the battery is at a low state of charge, the generator is kept in the current operating state, and the battery is charged. In addition, electric signals (flip-flop signal and magneto signal) of the magneto may be acquired by the isolation control module of the bidirectional module to accurately determine whether the magneto (engine) is in an operating state.

In a normal working scenario, (1) if the voltage of the battery is lower than 30% and the magneto (engine) is in a non-operating state, the MCU voltage detection and control module sends a control signal to the magneto (engine) to control the magneto (engine) to start; at this moment, the generator set is in the operating state, and the battery is in the charge state until it is fully charged; when the battery is fully charged, the engine stops operating in absence of a discharge current of an external load. Wherein, the battery starts the engine by means of a starting motor arranged between the battery and the bidirectional module; or, the isolation control module in the bidirectional module is replaced with a reverse starting module, the battery starts the engine by reverse starting. (2) If the voltage of the battery is lower than 30% and the magneto (engine) is in the operating state, no action will be performed, and the engine is kept in the operating state. (3) If the engine interrupted due to a fault, the MCU voltage detection and control module sends a signal, the engine operates, and when the battery is fully charged, the MCU voltage detection and control module sends a signal to control the engine to stop operating.

In short, the charge/discharge state of the battery can be determined by means of the voltage detection module for detecting a voltage drop of the diode and the two current detection modules at the charge terminal and the discharge terminal; then, the MCU voltage detection and control module controls the generator according to the charge/discharge state of the battery. When the battery is at a low state of charge/the battery runs down, the battery will be charged; and when the battery is fully charged and there is no load, the generator set stops.

Although the embodiments of the invention have been illustrated and described above, those ordinarily skilled in the art can appreciate that various amendments, modifications, substitutions and transformations can be made to these embodiments without departing from the principle and concept of the invention. The scope of the invention should be defined by the appended claims and their equivalents.

What is claimed is:

1. A hybrid power system for a generator set, comprising an engine, an inverter, a battery and a bidirectional module, wherein the bidirectional module is connected to the inverter, the battery and the engine;
voltage detection is arranged at a low-voltage battery terminal of the bidirectional module to detect a voltage of the battery terminal; when the voltage of the low-voltage battery terminal of the bidirectional module is higher than a set voltage threshold, it is determined that the battery is at a high state of charge;
the bidirectional module comprises a step-down charge channel and a step-up discharge channel, and monitoring elements are arranged at two terminals of the step-down charge channel and two terminals of the step-up discharge channel; specifically:
a diode is arranged at a high-voltage terminal of the step-up discharge channel of the bidirectional module, the high-voltage terminal of the step-up discharge channel of the bidirectional module is connected to an anode of the diode, and a voltage to ground of the anode of the diode is U1; a cathode of the diode is connected to the inverter, and a voltage to ground of the cathode of the diode is U0; voltage detection is arranged at two terminals of the diode to detect a voltage difference signal u of the diode, u=U1−U0; when u is greater than 0, it indicates that the engine does not operate, and a generator set is in a non-operating state; and when u is less than or equal to 0, it indicates that the engine operates, and the generator set is in an operating state;
current detection is arranged at a low-voltage terminal of the step-up discharge channel of the bidirectional module, and current detection is arranged at a low-voltage terminal of the step-down charge voltage channel of the bidirectional module;
the bidirectional module controls the step-down charge voltage channel and the step-up discharge channel to be opened or closed according to the voltage of the battery terminal;
(1) when the battery is at a high state of charge, the step-up discharge channel is opened, the step-down charge channel is closed, and the battery is in a discharge state;
(2) when a voltage of the battery is lower than a charge threshold, the bidirectional module closes the step-up discharge channel and opens the step-down charge channel, and the battery is in a charge state;
(3) when the battery is at a high state of charge and the generator set operates, the step-up discharge channel and the step-down charge channel are opened at the same time, the battery is charged while discharging, and the battery is in both the charge state and the discharge state;
(4) when the generator set does not operate and the inverter does not output a current, the step-up discharge channel and the step-down charge channel are closed at the same time; whether the inverter outputs a current is determined by the current detection arranged at the low-voltage terminal of the step-down charge channel.

2. The hybrid power system for a generator set according to claim 1, wherein the step-up discharge channel and the step-down charge channel of the bidirectional module are opened by default.

3. The hybrid power system for a generator set according to claim 1, further comprising a start-stop control module, wherein the start-stop control module is connected to the bidirectional module and the engine and used for starting and stopping the engine;
in a case where the battery is at a high state of charge, the step-up discharge channel is opened and the step-down charge channel is closed, the bidirectional module sends a signal to the start-stop control module to control the engine to stop so as to stop the generator set;
in a case where the voltage of the battery is lower than the charge threshold and the bidirectional module closes the step-up discharge channel and opens the step-down charge channel, the bidirectional module sends a signal to the start-stop control module to control the engine to start so as to start the generator set.

4. The hybrid power system for a generator set according to claim 3, wherein the engine is started by the start-stop control module or by reverse starting.

5. The hybrid power system for a generator set according to claim 1, wherein when the battery is in the discharge state, a current output by the battery is boosted by the step-up discharge channel of the bidirectional module and then inverted and rectified by the inverter, and a current output by the inverter is used for power supply to a load.
